(19) United States
(12) Patent Application Publication
(10) Pub. No.: US 2012/0051064 A1
(43) Pub. Date: Mar. 1, 2012

(54) LUMINOUS MEANS, CABLE HARNESS AND INTERIOR TRIM ELEMENT

(75) Inventors: Dirk-Achim SCHEVARDO, Haimendorf (Roethenbach) (DE); Ulli ANHORN, Laichingen (DE); Oliver KLETTKE, Nuernberg (DE); Rüdiger SCHLOSSER, Schwabach (DE); Thomas GEUDNER, Maselheim (DE)

(73) Assignees: DIEHL AIRCABIN GMBH, Laupheim (DE); DIEHL AEROSPACE GMBH, Ueberlingen (DE)

(21) Appl. No.: 13/217,899

(22) Filed: Aug. 25, 2011

(30) Foreign Application Priority Data
Sep. 1, 2010 (DE) 10 2010 036 101.1

(51) Int. Cl. F21V 21/00; F21V 11/00

(52) U.S. Cl. 362/311.01; 362/382; 362/391

(57) ABSTRACT

The present invention is directed to a luminous means comprising at least one light-emitting diode which is at least partly accommodated in a connection block, wherein electrical connections of the at least one light-emitting diode exit from the connection block in an angled fashion relative to the preferred light emission direction (M). The invention is further directed to a cable harness comprising at least one of said luminous means, as well as to an interior trim element comprising said luminous means.

### BACKGROUND OF THE INVENTION

In the case of aircraft cabins it is known to provide ceiling or wall lining elements with luminous means incorporated therein. When the luminous means are driven in a suitable manner, one or more desired luminous patterns can be represented. Such a luminous pattern can be, for example, individual light or luminous spots which are distributed over one or more lining elements and in their totality produce an image, such as e.g. a star image representation of the starry sky. In order to generate the light or luminous spots, light-emitting diodes or optical waveguides can be incorporated in the lining element itself. The light-emitting diodes or optical waveguides are usually inserted in holes in the lining elements.

### DISCUSSION OF THE PRIOR ART

Given complex distribution of the light or luminous spots over a lining element, the outlay for equipment with light sources and the cabling thereof is extremely high. For equipment and/or cabling purposes, according to the previous prior art, it is possible to use flexible printed circuit board films, for example, which, at the locations required for generating the image, already have luminous elements, such as light-emitting diodes (LED), or contacts for connection to luminous elements. However, printed circuit board films leave only little free space with regard to the installation location of the light-emitting diodes. Altering the image correspondingly requires the use of correspondingly altered printed circuit board films. A further possibility, which is flexible with regard to the equipment of different images, consists in using LED chains. However, the equipment of the lining element or of predefined holes in the lining element with light-emitting diodes and also the cable routing and cable fixing are comparatively complicated here.

### SUMMARY OF THE INVENTION

It is an object of the invention to avoid the disadvantages according to the prior art.

This object is achieved by means of the independent patent claims. Advantageous configurations emerge from the dependent patent claims.

A first aspect of the invention provides a luminous means, more particularly an LED-based luminous means, which comprises a connection block with at least one LED integrated or accommodated at least partly therein. The connection block can be embodied in a cube-like manner, in particular. The connection block can be a housing-like structure, for example, in or on which one or more light-emitting diodes can be fitted, accommodated or integrated. The at least one light-emitting diode can be encapsulated at least in sections in the connection block or be mounted in an exchangeable manner therein.

Electrical connections such as, for example, connection cables and/or contact elements for the light-emitting diodes preferably exit at a predefined angle relative to the preferred light emission direction or installation direction. The electrical connections thus run in angled fashion with respect to the preferred light emission direction. This manner of fitting the electrical connections makes it possible to avoid unnecessarily small bending radii that could lead to damage to the connection cables. Very small bending radii can occur in known luminous means, for example, if electrical connections are led away parallel to the preferred light emission direction and the structural space is restricted in this direction for instance by covers, walls and the like.

The connection block can be embodied in such a way that the electrical connections exit from the connection block at a predetermined distance from the light-emitting diode. In this way, the electrical connections, such as connection cables or contact elements, can exit from the connection block in such a way that, in the case where the LED-based luminous means is mounted on an interior trim element or panel, they maintain a predetermined minimum distance from the panel. The interior trim element can be an interior trim element for aircraft cabins.

The connection block can have a screen, by means of which the at least one light-emitting diode and possible further electronic components are screened relative to external effects. The screen can constitute, for example, damping elements for absorbing impacts and the like. It is also possible for the screen to have a grid or similar structures for electromagnetically screening the light-emitting diode and possible components. Furthermore, the screen can be embodied in such a way that electrostatic discharges (ESD) can be avoided.

The connection block can be configured in such a way that it can be connected to securing elements on an interior trim element, or particularly on an interior trim element of an aircraft cabin, in a simple manner.

In one advantageous variant, the interior trim element has bushes, which can be integrated or mounted beforehand, or example. The bushes are advantageously embodied such that a connection block can be pushed in, latched in or locked in a simple manner, preferably in rereleasable fashion.

The connection block can be retained in a bush for example by mechanical friction, mechanical locking, etc. The holding force with which a connection block is retained by a bush or a securing element should in any event be high enough that the connection block is securely retained under customary stresses and vibrations and independent release from the securing element is avoided.

For maintenance and exchange, the connection block can be embodied in such a way that it can easily be released or pulled off again from the panel, in order, by way of example, to be able to exchange one or, if appropriate, a plurality of light-emitting diodes.

A second aspect of the invention provides a cable harness having at least one LED-based luminous means.

The cable harness can comprise light-emitting diodes which are housed and wired with connection cables, wherein the housed LEDs can be provided with in each case two connection cables, e.g. two very thin cores.

The cable harness can be dimensioned in such a way that an area of an interior trim element of approximately 1.5 m×1 m can be covered by a plurality or a multiplicity of luminous means with sufficient density.

The connection cables are preferably bundled in such a way that they support themselves at least in sections. What can be achieved in this way is that as few spacers as possible are required to maintain a predetermined minimum distance from the interior trim element.

Possible spacers which can be configured in the manner described below can be used for bundling connection cables. In particular, it is possible to bundle those sections of connection cables which run jointly along a cable harness path.

A cable harness provided according to a second aspect of the invention can comprise at least one spacer designed for securing connection cables fixed thereto at a predetermined distance on a support.

The spacers can have, in particular in a manner corresponding to the connection block, a cube shape, for example. The spacers can be applied or secured by adhesive bonding, screws, by a latching connection and the like on a support, such as e.g. an interior trim element.

The spacers can have cutouts or depressions designed for introducing and guiding connection cables at an end side remote from the interior trim element after mounting or securing on the interior trim element. In order to form the cutouts or depressions, for example crenulated elevations can be provided on the respective end side, such that the cutouts or depressions are formed by interspaces or trenches between the crenulations.

The cutouts or depressions can be provided, at the end side, with a cover that can be secured in a releasable manner, such that the connection cables are securely retained in the depressions or cutouts.

If necessary, that side of the cover which faces the cutouts in the mounted state and/or locations of the cutouts which face the cover can be embodied in such a way that a pressure force is exerted on the connection cables situated in the cutouts or depressions. By way example, elevations or compressively elastic materials can be used for generating the pressure force.

The cutouts or depressions preferably have internal radii such that bending radii that are to be maintained for the connection cables are not undershot.

A coarse branching or coarse orientation of the connection cables of the cable harness can be achieved by means of the spacers and the cutouts provided therein.

According to one advantageous configuration, the cable harness is prefabricated, wherein, in particular, the housed light-emitting diodes can be connected to corresponding connection cables, the connection cables can be bundled, in particular by means of the spacers, and/or spacers can be fitted to corresponding locations.

Furthermore, it is possible to fix the cable harness, that is to say the, more particularly bundled, connection cables of the cable harness, by means of a carrier layer, such as e.g. an adhesive film or a supporting grid, as early as prior to mounting onto the interior trim element. In this way it is possible to prevent free ends of connection cables of the cable harness from becoming caught or knotted in one another. Furthermore, by virtue of the fact that, in particular, the elements to be connected to the interior trim element, such as housed LEDs, connection plugs, spacers, etc., are fixed on the carrier layer, the cable harness can be finally mounted in a simple manner. The cable harness fixed on the carrier layer can be placed onto the interior trim element and oriented in such a way that the elements to be connected to the interior trim element become situated at corresponding locations, at least coarsely. At this stage, the elements to be connected can be connected to the interior trim element in a simple manner and in a comparatively short mounting time. After all the elements have been mounted on the interior trim element, the carrier layer can be removed, by being pulled off in the case of a film.

A cable harness which is prefabricated with spacers and other bundling elements in the coarse structure and is nevertheless flexible to a certain extent can be used, in particular, for different luminous patterns to be represented. By way of example, it is possible to use a cable harness having a predetermined distribution of the LED-based luminous means for different patterns of the connection bushes provided on the interior trim element for the housed LEDs. In order to realise different patterns, the ends of the connection lines can be correspondingly displaced and positioned. If necessary, it is also possible to displace the elements for bundling, such as e.g. the spacers, in the longitudinal direction of the connection cables, in order to establish different curvatures and cable profiles.

For further simplification of the mounting of the cable harness or for simplification of the pre-fixing of the cable harness on the carrier layer, the LED-based luminous means can have a marking or identification revealing the type of luminous means. Such an identification can indicate, for example, the power, colour, etc. of an LED-based luminous means. The markings or identifications can be imprints, stickers, pennants and the like.

After connection of all elements to be connected has been effected, the carrier layer can be removed or pulled off, and if appropriate reused for a further cable harness. Apart from simpler and faster mounting, the stockkeeping and/or transport of the cable harnesses can also be simplified by the carrier layer.

After the interior trim element has been equipped with a cable harness, the LED-based luminous means lie at perforations or light exit points or windows provided for generating the luminous pattern in the interior trim element. Upon corresponding driving of all or a corresponding selection of LED-based luminous means, a respectively desired luminous pattern or image can then be generated.

The spacers described further above can have a dual function. Firstly, the connection cables can thereby be bundled in a simple manner. Secondly, by means of the spacers, if appropriate with the aid of self-supporting properties of bundled connection cables, it can be ensured that the connection cables maintain a predetermined distance from the support, e.g. an interior trim element. The latter function makes it possible to prevent the insulations of the connection cables being damaged, in particular chafed, owing to vibrations or other relative movements.

The cable harness proposed enables simple mounting. Additional and often time-consuming mounting work on the support, e.g. the interior trim element, such as e.g. assembling more films, fixing superfluous cables and excess cable lengths whilst taking account of the bending radii etc. can be avoided. The cable harness equipped with LED-based luminous means constitutes a combined system composed of LED, connection cables, cable routing and cable fixing, which enables fast and precise mounting of the luminous means at corresponding positions of the interior trim element. In particular, it is possible for connection cables that have been suitably cut to length to be routed correctly, and to be fixed at a suitable distance from the support without further measures.

### BRIEF DESCRIPTION OF THE DRAWINGS

An exemplary embodiment of the invention is described below in association with the appended figures, in which:

FIG. 1 shows an exploded illustration of a portion of an interior trim element with an LED-based luminous means; and

FIG. 2 shows a portion of a cable harness fitted to an interior trim element.

### DETAILED DESCRIPTION OF THE INVENTION

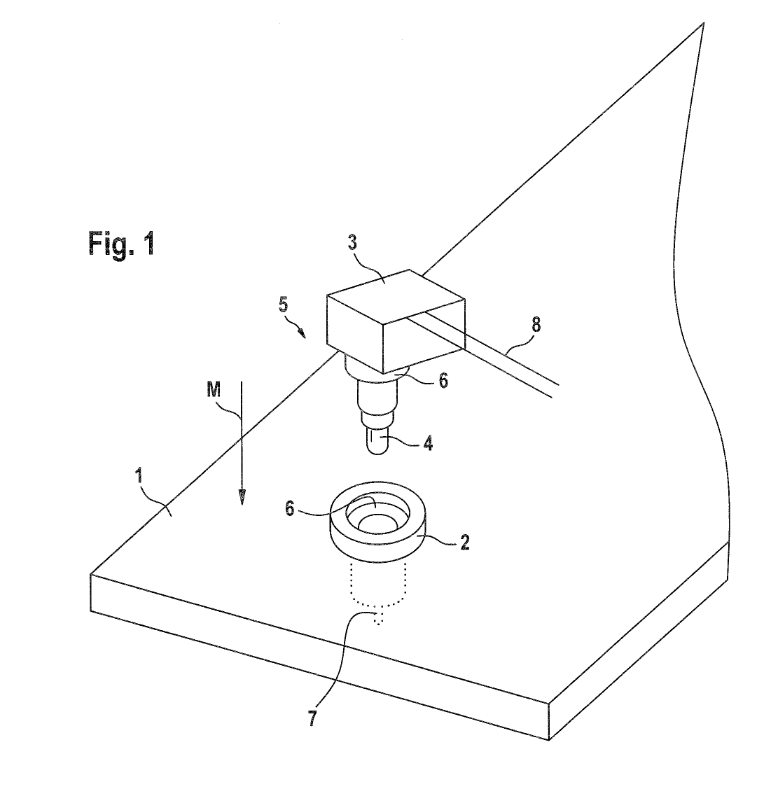

FIG. 1 shows an exploded illustration of a portion of an interior trim element 1. The interior trim element 1 has a bush 2, into which an LED-based luminous means, in the present case a light-emitting diode (LED) 4 retained and accommodated in a cube-like housing 3, can be inserted. The housing 3 with LED 4 is designated hereinafter as housed LED 5.

The bush 2 and the housed LED 5 have mutually corresponding holding elements 6, by means of which the housed LED 5 can be retained securely in the bush 2. The holding elements 6, which e.g. enable the housed LED 5 to be retained in a positively locking and/or force-locking manner, can furthermore or alternatively have latching elements, by means of which the housed LED 5 can be latched, more particularly latched in a releasable manner, in the bush 2.

In the mounted state, the LED 4 integrated with the cube-like housing 3 is situated in the bush 2, which is incorporated at least partly into the interior trim element 1. In the region in which the LED 4 becomes situated, the bush 2 has a form corresponding to the LED.

Light generated by the LED 4 exits through a light passage window 7 at a side of the interior trim element 1 which is remote from the bush 2, and generates a luminous effect, which can be part of a luminous pattern, for example of a star image, on the corresponding side of the interior trim element 1.

For improved coupling-out of the light, the bush 2 can be provided with suitable optical means, such as, for example, reflective coatings, coupling media and the like.

The housed LED 5 is furthermore connected to connection cables 8, which, in the present case, exit from the housing 3 at an angle of approximately 90 degrees relative to the mounting direction M, which corresponds to the preferred light emission direction, or are connected to corresponding electrical contacts.

In the case of connection cables routed in this way, by comparison with contact-connection on the top side of the housing 3, it is possible to prevent the occurrence of excessively small bending radii that could lead to damage to the connection cables 8.

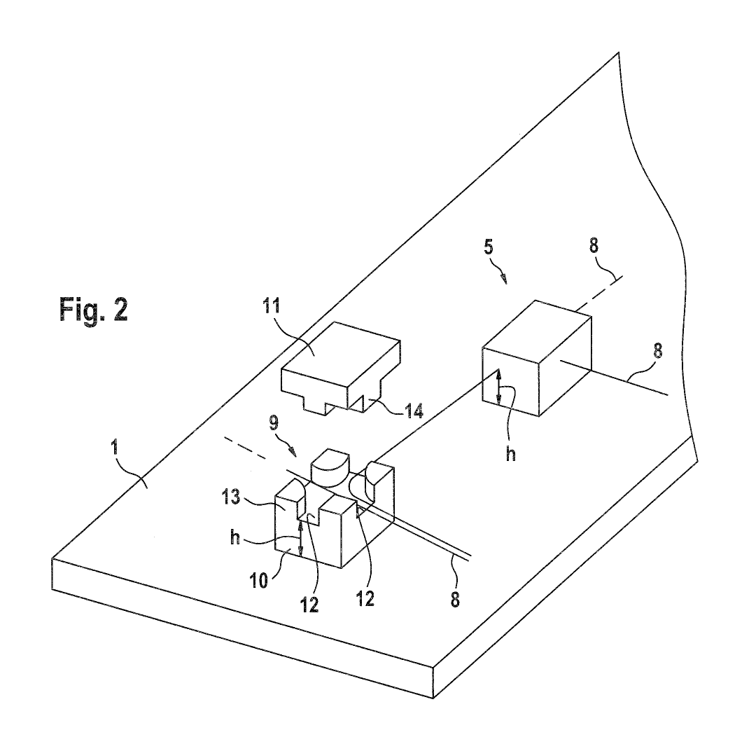

FIG. 2 shows a portion of a cable harness fitted to an interior trim element 1. The cable harness has at least one housed LED 5 described in association with FIG. 1, said housed LED here merely being illustrated as a cube for simplification.

The cable harness furthermore has spacers 9, just a single one of which is illustrated in FIG. 2 in an exploded illustration. The spacer 9 has a base body 10 and a cover 11, which can be connected to the base body in a releasable manner by means of a latching connection.

In the present case, two cutouts 12 running at an angle of 90 degrees with respect to one another are introduced in the base body 10, said cutouts being delimited by, in the present case, crenulated, projections 13. In configurations of the base body 10 it is possible for only one or more than two cutouts 12 to be present. For the case where two or more than two cutouts 12 are present, the latter can also form other angles with respect to one another, in contrast to FIG. 2.

The inner sides of the cutouts 12 or the inner walls of the projections 13 have a curvature, such that in any case of cable routing impermissible bending radii for the connection cables 8 routed in the cutouts 12 are avoided.

The base body 10 can be retained, more particularly retained in a releasable manner, on the interior trim element 1 by adhesive bonding, latching, by plugging and holding elements and/or by other securing means.

After the connection cables 8 have been introduced into the cutouts 12 in accordance with the required or desired cable profile, they can be secured therein by the placement of the cover 11. For this purpose, the cover 11 can have latching or clamping elements 14, for example, by means of which the cover 11 can be connected, preferably in a releasable manner, to the base body 10. Other securing variants are conceivable. The latching elements 14 as shown in FIG. 2 are embodied in such a way that they engage into the gaps between the projections 13 and latch with the projections 13.

For further or better fixing of the connection cables 8 in the cutouts 12, the cover 11, on the side facing the base body, can have an elastically deformable element or an elastically deformable coating or layer embodied in such a way that connection cables 8 situated in the cutouts 12 are pressed into the base of the cutouts 12. Provided that damage to the connection cables can be precluded, the elements can also be embodied as rigid, i.e. not elastically deformable. Alternatively or additionally it is also possible for the base body 10 to have corresponding elements, such that the connection cables 8 are additionally retained by a pressure force in the cutouts 12 closed toward the top by the cover 11.

As shown in FIG. 2, the spacers 9 or the cutouts 12 are embodied in such a way that connection cables 8 that are routed or retained thereby, more particularly that enter into or exit from them, run at a predetermined height h. In this way, if appropriate under the additional effect of the dimensional stability of the connection cables 8, it can be ensured that the connection cables 8 are sufficiently spaced apart from the interior trim element 1 along the entire length running over the interior trim element 1. It is thus possible to prevent insulations of the connection cables 8 from being worn through by vibrations or other relative movements over the course of time.

List of Reference Symbols:

1 Interior trim element

2 Bush

3 Housing

4 LED

5 Housed LED

6 Holding element

7 Light passage window

8 Connection cable

9 Spacer

10 Base body

11 Cover

12 Cutout

13 Projection

14 Latching or clamping element

M Mounting direction

h Height

What is claimed is:

1. A luminous means comprising at least one light-emitting diode which is at least partly accommodated in a connection block, wherein electrical connections of the at least one light-emitting diode exit from the connection block in an angled fashion relative to the preferred light emission direction (M).

2. The luminous means according to claim 1, wherein the connection block is embodied in such a way that the electrical connections exit from the connection block at a predetermined distance from the light-emitting diode.

3. The luminous means according to claim 1, wherein the connection block has a screen, by means of which the at least one light-emitting diode and possible further electronic components are screened relative to the surroundings.

4. A cable harness comprising at least one luminous means according to claim 1.

5. The cable harness according to claim 4, comprising at least one spacer designed for securing connection cables fixed thereto at a predetermined distance (h) on a support.

6. The cable harness according to claim 5, wherein the at least one spacer has cutouts designed for introducing and guiding connection cables, wherein the spacer preferably has a, more particularly releasable, cover, by means of which the cutouts can be closed at least at the end side of the spacer.

7. The cable harness according to claim 6, wherein the spacer has means that exert a pressure force on connection cables situated in the cutouts.

8. The cable harness according to claim 4, further comprising a carrier layer, on which elements of the cable harness are fixed in a releasable manner.

9. An interior trim element, comprising a luminous means according to claim 1 and at least one bush designed for mounting the luminous means.

10. The interior trim element according to claim 9, comprising a cable harness comprising at least one of said luminous means that is fitted thereto.
